(19) United States
(12) Patent Application Publication
(10) Pub. No.: US 2016/0239168 A1
(43) Pub. Date: Aug. 18, 2016

(54) METHOD AND SYSTEM OF GUI FUNCTIONALITY MANAGEMENT

(71) Applicant: SCREENOVATE TECHNOLOGIES LTD., Ra'anana (IL)

(72) Inventors: Joshua GLAZER, Ra'anana (IL); Michael SHEINKER, Arad (IL)

(21) Appl. No.: 15/046,626

(22) Filed: Feb. 18, 2016

Related U.S. Application Data
(60) Provisional application No. 62/117,483, filed on Feb. 18, 2015.

(51) Int. Cl. G06F 3/0484; G06F 3/01; G06F 3/0481; G06F 3/14; G06F 3/0346

(52) U.S. Cl. CPC G06F 3/0484; G06F 3/1454; G06F 3/0346; G06F 3/0481; G06F 3/017

(57) ABSTRACT

A method is provided for managing a graphical user interface (GUI) of a mobile device in association with a target screen device, wherein the screen image is mirrored between the mobile device and target screen. The method includes analyzing user real time behavior of using mobile device, based on monitored data of mobile device sensors, comparing current usage pattern to pre-defined usage patterns of the mobile device, determining usage case based on analyzed behavior and comparison to pre-defined usage patterns and determining GUI functionality to be activated for each use case. A system is also provided for managing a GUI of mobile device in association with a target screen device, wherein the screen image is mirrored between the mobile device and target screen,

### TECHNICAL FIELD

The present invention generally relates to the field of managing Graphical User Interface (GUI) functionality and more specifically managing functionality in relation to remote display device.

### SUMMARY OF THE INVENTION

The present invention provides a method for managing GUI interface of mobile device in association with a target screen device, wherein the screen image is mirrored between the mobile device and target screen. The method comprising the steps of: analyzing user real time behavior of using mobile device, based on monitored data of mobile device sensors, comparing current usage pattern to pre-defined usage patterns of the mobile device, determining usage case based on analyzed behavior and comparison to pre-defined usage patterns and determining GUI functionality to be activated for each use case.

At least one of analyzing, comparing, determining, is a performed by at least one processor.

According to some embodiments of the present invention, the method further comprising the step of identify activated application type and usage characteristics including, user interaction frequency.

According to some embodiments of the present invention the GUI functionality is applied by activating the respective GUI application.

According to some embodiments of the present invention the behavior of the user includes positioning the mobile device or moving the mobile device.

According to some embodiments of the present invention the device sensors include at least one of the following: gyroscope sensor, accelerometer sensor, camera.

According to some embodiments of the present invention the analyzing include checking gyroscope data for identifying mobile device tilting orientation movements;

The method of claim 1 wherein the determining of lean back or lean forward use cases is determined when identifying specific orientation position maintained for predefined time period at pre-defined angle in relation to the user position or in relation to the remote screen

According to some embodiments of the present invention the analyzing include analyzing accelerometer data to identify motion pattern of the device.

According to some embodiments of the present invention the method further comprising the step of recording personal user behavior pattern, learning the association between the usage pattern and actual GUI functionality of the mobile device, wherein the current usage pattern is compared to personal predefined usage pattern.

According to some embodiments of the present invention wherein the GUI functionality include at least one of: remote control or game interface.

According to some embodiments of the present invention the usage case is at least one of: lean back where the user is passive, lean forward where the user is active.

The present invention provides a system for managing GUI interface of mobile device in association with a target screen device, wherein the screen image is mirrored between the mobile device and target screen. The system is comprised of: User behavior analysis module for analyzing user real time behavior of using mobile device, based on monitored data of mobile device sensors, comparing current usage pattern to pre-defined usage patterns of the mobile device and GUI management for determining usage case based on analyzed behavior and comparison to pre-defined usage patterns and determining GUI functionality to be activated for each use case;

According to some embodiments of the present invention the behavior analysis module further comprising the step of identifying activated application type and usage characteristics including user interaction frequency.

According to some embodiments of the present invention the GUI functionality is applied by activating the respective GUI application.

According to some embodiments of the present invention the behavior of the user includes positioning the mobile device or moving the mobile device.

According to some embodiments of the present invention the device sensors include at least one of the following: gyroscope sensor, accelerometer sensor, and camera.

According to some embodiments of the present invention the User behavior analysis module further include the step of analyzing gyroscope data for identifying mobile device tilting orientation movements;

According to some embodiments of the present invention the analyzing include analyzing accelerometer data to identify motion pattern of the device.

According to some embodiments of the present invention the determining of lean back or lean forward use cases is determined when identifying specific orientation position maintained for predefined time period at pre-defined angle in relation to the user position or in relation to the remote screen.

According to some embodiments of the present invention the user behavior analysis module further comprising the step of recording personal user behavior pattern, learning the association between the usage pattern and actual GUI functionality of the mobile device, wherein the current usage pattern is compared to personal predefined usage pattern.

According to some embodiments of the present invention the GUI functionality include at least one of: remote control or game interface.

According to some embodiments of the present invention the usage case is at least one of: lean back where the user is passive functioning as a remote control using only one hand, lean forward where the user is active, to be able to control a video or video game, using the sensors measurements to identify movement of the mobile device in space left/right or up/down, while holding the mobile device with two hands.

### BRIEF DESCRIPTION OF THE DRAWINGS

The present invention will be more readily understood from the detailed description of embodiments thereof made in conjunction with the accompanying drawings of which:

FIG. 1 is a block diagram, illustrating the modules of the GUI functionality management, according to some embodiments of the invention;

FIG. 2 is a flowchart illustrating a process of User behavior module, according to some embodiments of the invention;

FIG. 3 is a flowchart illustrating a process of a GUI management module, according to some embodiments of the invention;

FIG. 4 is a flowchart illustrating a process of Personal behavior analysis module, according to some embodiments of the invention;

FIGS. 5 is a block diagram illustrating a first example of the screen GUI display on a computerized device and on a target display according to some embodiments of the invention;

FIGS. 6 is a block diagram illustrating a second example of the screen GUI display on a computerized device and on a target display according to some embodiments of the invention; and

FIGS. 7A, 7B are exemplary illustrations, of the mobile device orientation position for each GUI use case functionality according to some embodiments of the invention.

### DETAILED DESCRIPTION

Before explaining at least one embodiment of the invention in details, it is to be understood that the invention is not limited in its application to the details of construction and the arrangement of the components set forth in the following description or illustrated in the drawings. The invention is applicable to other embodiments and/or may be practiced or carried out in various ways. Also, it is to be understood that the phraseology and terminology employed herein is for the purpose of description and should not be regarded as limiting.

The term “target display” as used herein in this application is defined as a display monitor for playing images or video such a Television (TV) screen, or a computerized device screen.

The term “screen GUI” as used herein in this application is define as data and appearance of application screens such as messaging application screen or an application screen.

The application refers to a computerized device as an example and may be implemented to any multimedia device such as tablet computer, laptop computer or any other computerized device.

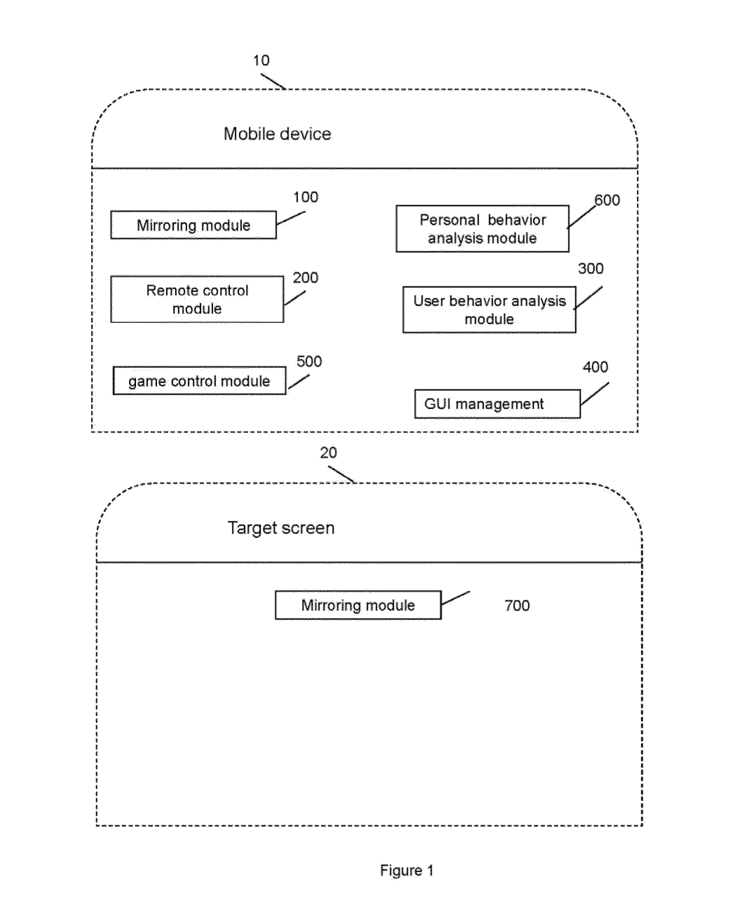

FIG. 1 is a block diagram, illustrating the modules of the GUI functionality management, according to some embodiments of the invention. User behavior module analysis 300 enable monitoring user behavior based on sensors measurements, type of usage of the application, the monitored information is analyzed to identify behavior pattern. Based on identified behavior pattern, the GUI management module 400 can identify usage case and accordingly determine the GUI functionality. The functionality may include one of the following: mirroring mode implemented by the mirroring module 100 to enable the user viewing the content of the remote screen on the mobile device, remote control mode implemented by remote control module 200 enabling to use the mobile device as controller for the remote screen, or gaming mode implemented by game control module 500 supporting gaming console emulation for gamed played on the remote screen.

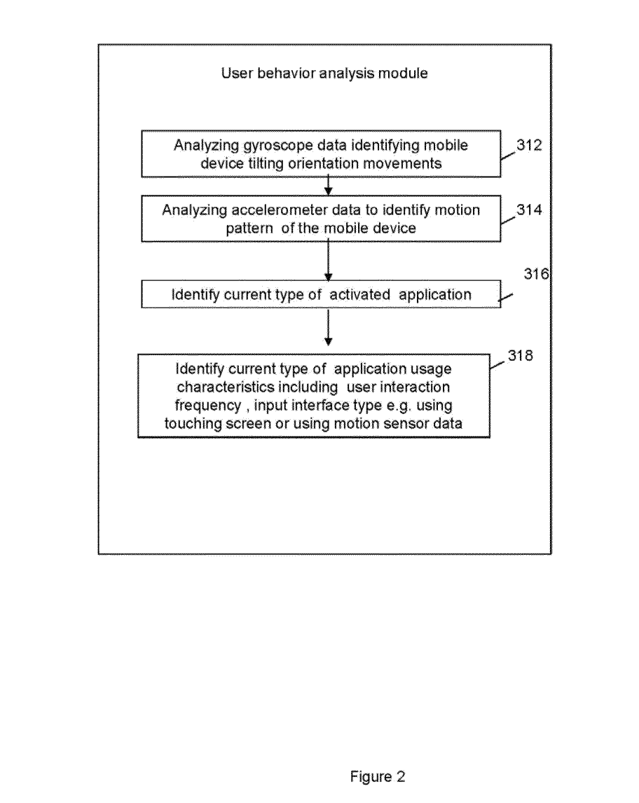

FIG. 2 is flowchart illustrating a process of user behavior analysis module, according to some embodiments of the invention. The processing of this module include at least one of the following steps: Analyzing gyroscope data for identifying mobile device tilting orientation movements, enabling to identify the relative position of the phone in relation to remote screen or the user or (step 312), analyzing accelerometer data to identify motion pattern (step 314), identify current type of activated application such as utility application, gaming application, multimedia application etc. (step 316) or identifying current type of application usage such typing, scrolling, touching etc.

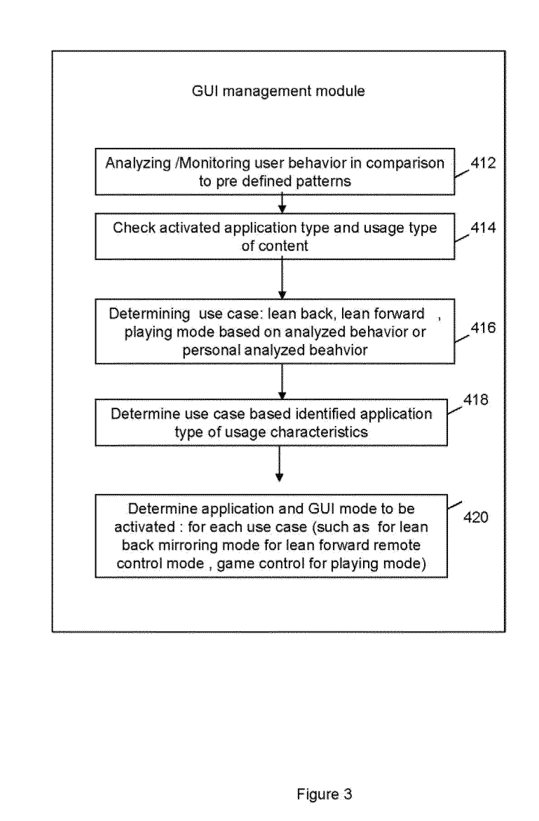

FIG. 3 is a flowchart illustrating a process of a GUI management module, according to some embodiments of the invention. The module processing include at least one of the following steps: analyzing user behavior in comparison to pre-defined patterns (step 412), checking activated application type and usage type of application (step 414), determining use case, such as, lean back, lean forward playing mode based on identified pattern (step 416) Determine use case based identified application type of usage characteristics (step 418) and determine application and GUI functionality to be activated (step 420): for each use case. For example: in case of identifying lean back uses triggers activating mirroring GUI functionality by activating the mirroring module. In case of identifying lean forward use case, triggering the remote control mode. In case of identifying use case of game control triggering game control module for emulating game console.

Lean back/lean forward, use cases may be identified when identifying specific orientation such as horizontal position, or vertical position maintained for predefined time period and/or tilting the mobile device at pre-defined angle in relation to the user position and in relation to the remote screen. The use case can determined by identifying behavior pattern of mobile phone motion: intensive movement may indicate of playing uses case, moving the phone toward the user may indicate of mirroring use case, moving the phone away from the user may indicate of remote control use case.

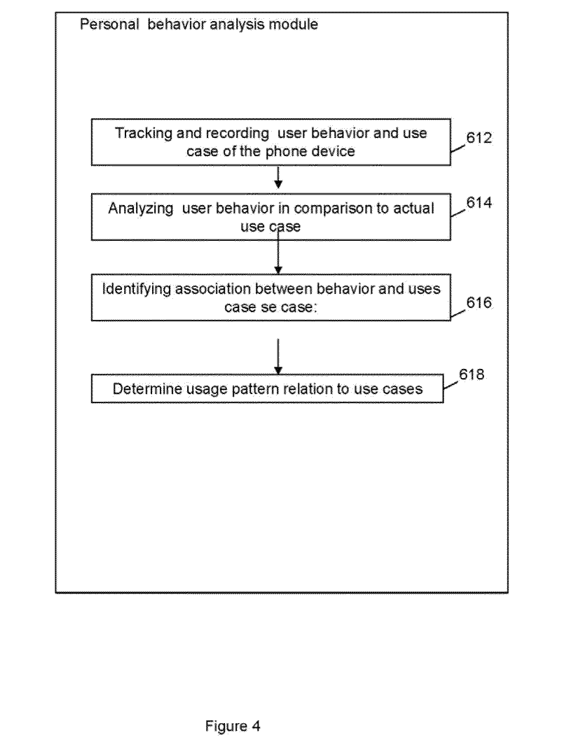

FIG. 4 is a flowchart illustrating a process of Personal behavior analysis module, according to some embodiments of the invention. The module processing include at least one of the following steps: Tracking and recording user behavior and use case of the phone device (step 612), analyzing user behavior in comparison to actual use case (step 614), identifying association between behavior and uses case se case (step 616) and/or determine usage pattern relation to use cases (step 618).

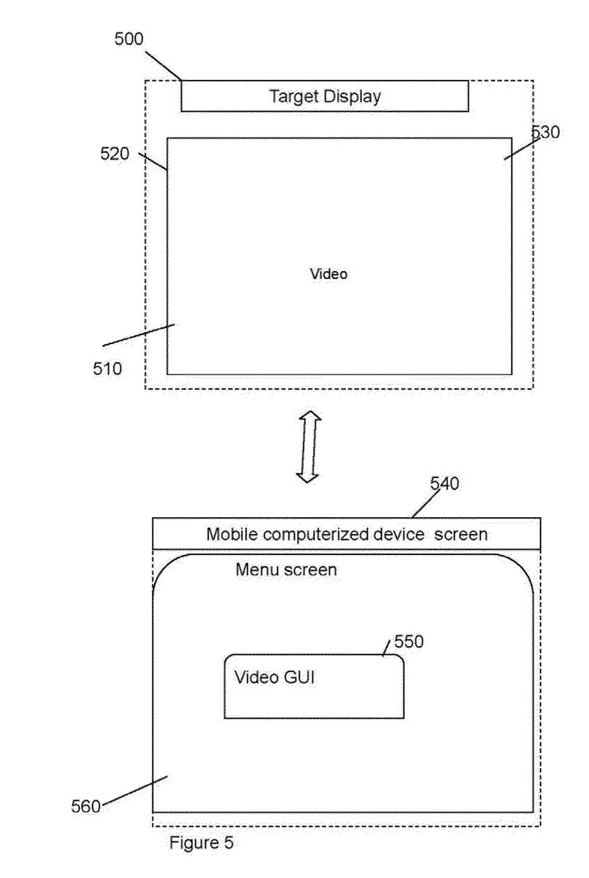

FIGS. 5 is a block diagram illustrating a first example of the screen GUI display on a computerized device and on a target display according to some embodiments of the invention. In this example, a video application is active and the identified use case is remote control, accordingly a video interface GUI is activated and displayed on the mobile.

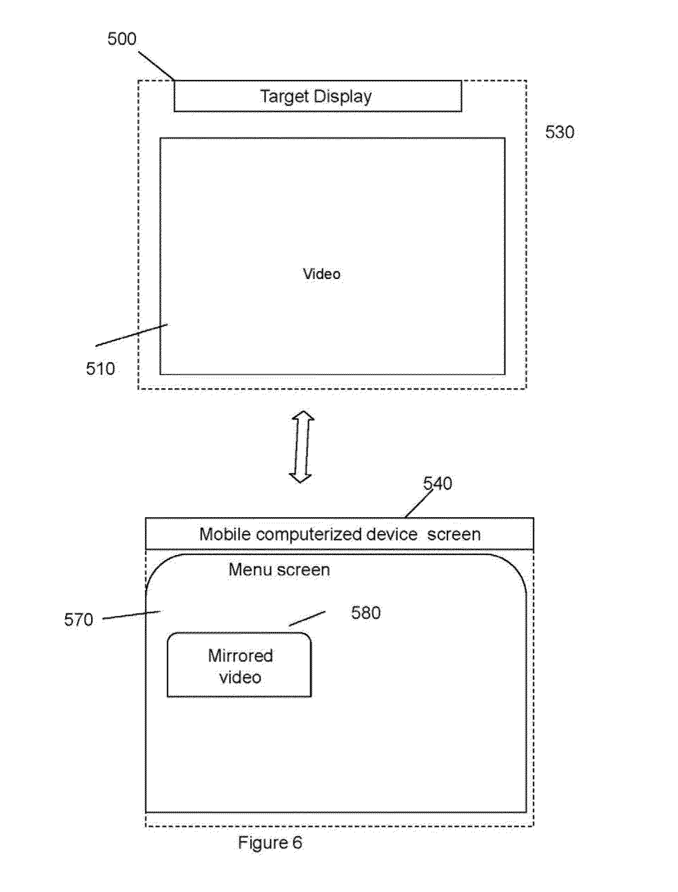

FIGS. 6 is a block diagram illustrating a second example of the screen GUI display on a computerized device and on a target display according to some embodiments of the invention. In this example, a video application is active and the identified use case is a mirroring, accordingly a video is streamed and displayed on the mobile device.

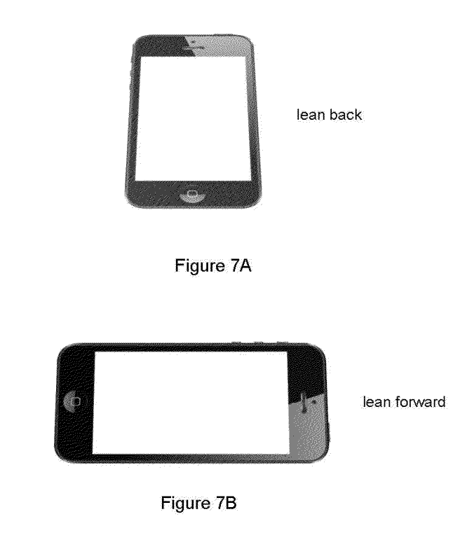

FIGS. 7A and 7B are exemplary illustrations of the mobile device orientation position for each GUI use case functionality. FIG. 7A illustrates an example of orientation and tilting positioned which characterize Lean back use case. FIG. 7B illustrates an example of orientation and tilting positioned which characterize Lean forward use case.

Lean back use case is when the phone is in portrait mode functioning a remote control using only one hand, lean forward use case is when the device is in landscape mode to be able to control a video or video game, using the sensors measurements to identify movement the mobile device in space left/right or up/down, while holding the mobile device with two hands.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware, if desired, using conventional techniques. Conversely, components described herein as hardware may, alternatively, be implemented wholly or partly in software, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code, such as executable code, having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; electronic devices each including a processor and a cooperating input device and/or output device and operative to perform in software any steps shown and described herein; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any step described herein may be computer-implemented. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention which are described in the context of separate embodiments may also be provided in combination in a single embodiment.

For example, a system embodiment is intended to include a corresponding process embodiment. Also, each system embodiment is intended to include a server-centered “view” or client centered “view”, or “view” from any other node of the system, of the entire functionality of the system, computer-readable medium, apparatus, including only those functionalities performed at that server or client or node.

What is claimed is:

1. A method for managing a graphical user interface (GUI) of mobile device in association with a target screen device, wherein the screen image is mirrored between the mobile device and target screen, said method comprising the steps of:
analyzing user real time behavior of using mobile device, based on monitored data of mobile device sensors;
comparing current usage pattern to pre-defined usage patterns of the mobile device;
determining usage case based on analyzed behavior and comparison to pre-defined usage patterns; and
determining GUI functionality to be activated for each use case;
wherein at least one of analyzing, comparing, determining, is a performed by at least one processor.

2. The method of claim 1, further comprising the step of identify activated application type and usage characteristics including, user interaction frequency.

3. The method of claim 1, wherein the GUI functionality is applied by activating the respective GUI application.

4. The method of claim 1, wherein the behavior of the user includes positioning the mobile device or moving the mobile device.

5. The method of claim 1, wherein device sensors include at least one of the following: gyroscope sensor, accelerometer sensor, camera.

6. The method of claim 1, wherein the analyzing include processing gyroscope data for identifying mobile device tilting orientation movements.

7. The method of claim 1, wherein the determining of lean back or lean forward use cases is determined when identifying specific orientation position maintained for predefined time period at pre-defined angle in relation to the user position or in relation to the remote screen.

8. The method of claim 1, wherein the analyzing include analyzing accelerometer data to identify motion pattern of the device.

9. The method of claim 1, further comprising the step of recording personal user behavior pattern, learning the association between the usage pattern and actual GUI functionality of the mobile device, wherein the current usage pattern is compared to personal predefined usage pattern.

10. The method of claim 1, wherein the GUI functionality include at least one of: remote control or game interface.

11. The method of claim 1, wherein the usage case is at least one of: lean back where the user is passive, lean forward, where the user is active.

12. A system for managing a graphical user interface (GUI) of mobile device in association with a target screen device, wherein the screen image is mirrored between the mobile device and target screen, said system comprising:
user behavior analysis module for analyzing user real time behavior of using mobile device, based on monitored data of mobile device sensors and comparing current usage pattern to pre-defined usage patterns of the mobile device; and
GUI management for determining usage case based on analyzed behavior; and
determining GUI functionality to be activated for each use case.

13. The system of claim 12, wherein the behavior analysis module further comprising the step of identifying activated application type and usage characteristics including user interaction frequency.

14. The system of claim 12, wherein the GUI functionality is applied by activating the respective GUI application.

15. The system of claim 12, wherein the behavior of the user includes positioning the mobile device or moving the mobile device.

16. The system of claim 12, wherein device sensors include at least one of the following: gyroscope sensor, accelerometer sensor, camera.

17. The system of claim 12, wherein the user behavior analysis module further include the step of analyzing gyroscope data for identifying mobile device tilting orientation movements.

18. The system of claim 12, wherein the analyzing include analyzing accelerometer data to identify motion pattern of the device.

19. The system of claim 18, wherein the determining of lean back or lean forward use cases is determined when identifying specific orientation position maintained for predefined time period at pre-defined angle in relation to the user position or in relation to the remote screen.

20. The system of claim 12, wherein the user behavior analysis module further comprising the step of recording personal user behavior pattern, learning the association between the usage pattern and actual GUI functionality of the mobile device, wherein the current usage pattern is compared to personal predefined usage pattern.

21. The system of claim 12, wherein the GUI functionality include at least one of: remote control or game interface.

22. The system of claim 12, wherein the usage case is at least one of: lean back where the user is passive functioning as a remote control using only one hand,, lean forward where the user is active, to be able to control a video or video game, using the sensors measurements to identify movement of the mobile device in space left/right or up/down, while holding the mobile device with two hands.
